(19) United States
(12) Patent Application Publication
(10) Pub. No.: US 2025/0285324 A1
(43) Pub. Date: Sep. 11, 2025

(54) METHOD AND VEHICLE-MOUNTED SYSTEM FOR HEAD POSTURE JUDGMENT

(71) Applicant: VIA TECHNOLOGIES, INC., New Taipei City (TW)

(72) Inventors: Juan HE, Beijing (CN); Chao-Chin CHANG, New Taipei City (TW)

(21) Appl. No.: 19/019,952

(22) Filed: Jan. 14, 2025

(30) Foreign Application Priority Data
Mar. 6, 2024 (CN) 202410256769.3

(51) Int. Cl. G06T 7/73

(52) U.S. Cl. CPC G06T 7/73; G06T 2207/20081; G06T 2207/30196; G06T 2207/30208; G06T 2207/30268

(57) ABSTRACT

A method for head posture judgment is provided. A plurality of head images are received to obtain raw label data corresponding to the head images. The raw label data include Euler angles marked in order of the x-y-z directions. The raw label data are converted into updated label data. The updated label data include Euler angles marked in order of the y-x-z directions. The updated label data of the head images are input into a deep learning network model. A loss function is used to train the deep learning network model to obtain a head posture detection model. Calibration images and real-time images are input into the head posture detection model to determine head posture.

### CROSS REFERENCE TO RELATED APPLICATIONS

This application claims priority of China Patent Application No. 202410256769.3, filed on Mar. 6, 2024, the entirety of which is incorporated by reference herein.

### BACKGROUND OF THE INVENTION

### Field of the Invention

The present invention relates to a visual image processing method, and, in particular, to a method and a vehicle-mounted system for head posture judgment.

### Description of the Related Art

At present, monocular image visual processing technology is mainly based on deep networks for end-to-end learning of the Euler angles of the head posture from monocular images However, there are still many problems with head posture detection. The main problem is that when the head rotates left or right at a large angle, such as when it rotates left or right close to 90 degrees, the detection result is unstable due to the generation of Gimbal lock. Large-angle rotation of the head left or right is one of the most dangerous behaviors that require key monitoring of drivers.

The detection results for large angles are unstable because the current head posture estimation dataset uses the x-y-z Euler angle annotation method. Once the second dimension turning angle (for example, y) is close to 90 degrees, the Gimbal lock problem arises.

Existing technology uses quaternion-based expressions to overcome the Gimbal lock problem, but quaternions lack intuitiveness compared to Euler angles, and subsequent processing is more complicated.

### BRIEF SUMMARY OF THE INVENTION

An embodiment of the present invention provides a method for head posture judgment. The method includes the following steps. A plurality of head images are received to obtain raw label data corresponding to the head images. The raw label data include Euler angles marked in order of the x-y-z directions. The raw label data are converted into updated label data. The updated label data include Euler angles marked in order of the y-x-z directions. The updated label data of the head images are input into a deep learning network model. A loss function is used to train the deep learning network model to obtain a head posture detection model. Calibration images and real-time images are input into the head posture detection model to determine head posture.

An embodiment of the present invention also provides a vehicle-mounted system, which includes a camera and a processor. The camera outputs a plurality of head images. The head images at least include calibration images and real-time images. The processor is electrically connected to the camera, which is used to receives the head images to obtain raw label data corresponding to the head images. The raw label data include Euler angles marked in order of the x-y-z directions. The processor converts the raw label data into updated label data, which include Euler angles marked in order of the y-x-z directions. The processor inputs the updated label data of the head images into a deep learning network model, and uses a loss function to train the deep learning network model to obtain a head posture detection model. The processor inputs the calibration images into the head posture detection model to obtain a set of reference Euler angles and inputs the real-time images into the head posture detection model to obtain a set of predicted Euler angles. Ultimately, according to the set of reference Euler angles and the set of predicted Euler angles to determines the head posture.

The method for head posture judgment and a vehicle-mounted of the present invention have the following advantages. First, the detection network has a small computation load and simple post-processing, resulting in a short overall processing time. It is highly suitable for application scenarios with limited computing power, such as in-vehicle-equipment, and can meet the real-time requirements in practical applications. Second, the detection output angles are more stable and smoother. Even in cases of large head rotations, the detection results remain highly stable and accurate, with strong robustness across various scenarios.

### BRIEF DESCRIPTION OF THE DRAWINGS

The present invention can be more fully understood by reading the subsequent detailed description and examples with references made to the accompanying drawings, wherein:

FIG. 1 shows a flow chart of a method for head posture judgment in accordance with some embodiments of the present invention;

FIG. 2 shows a schematic diagram of steps S100 and S102 in FIG. 1 and a schematic diagram of a head image 200 in accordance with some embodiments of the present invention;

FIG. 3 shows a detail flow chart of step S102 in FIG. 1 in accordance with some embodiments of the present invention;

FIG. 4 shows a detail flow chart of step S104 in FIG. 1 in accordance with some embodiments of the present invention;

FIG. 5 shows a detail flow chart of step S110 in FIG. 1 in accordance with some embodiments of the present invention;

FIG. 6 shows a schematic diagram of a structure of a deep learning network model in step S104 in FIG. 1 in accordance with some embodiments of the present invention;

FIG. 7 shows a schematic diagram of a vehicle-mounted system 700 in accordance with some embodiments of the present invention; and

FIG. 8 shows a schematic diagram of coordinate axes of a driver's head and their corresponding rotation angles in accordance with some embodiments of the present invention.

### DETAILED DESCRIPTION OF THE INVENTION

Reference will now be made in detail to exemplary embodiments of the present invention, examples of which are illustrated in the accompanying drawings.

Whenever possible, the same reference numbers are used in the drawings and the description to refer to the same or like parts.

In order to better understand the present invention, the relevant terms involved in the present invention are first explained as follows.

Gimbal lock is a problem that occurs when using dynamic Euler angles to represent the rotation of a three-dimensional object. Once the second rotation angle close to ±90°, the first and third rotations will be equivalent. The entire rotation representation system is limited to rotating only around the vertical axis, and a representation dimension is lost.

Euler angle is the angle at which an object rotates around the three axes of the coordinate system (x, y, and z axes), which is a set of three Euler angles.

Pitch is the angle formed by rotation around the X axis.

Yaw is the angle formed by rotation around the Y axis.

Roll is the angle formed by rotation around the Z axis.

Concat operation (CONCAT function) is used to connect two or more matrices.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first” and “second” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

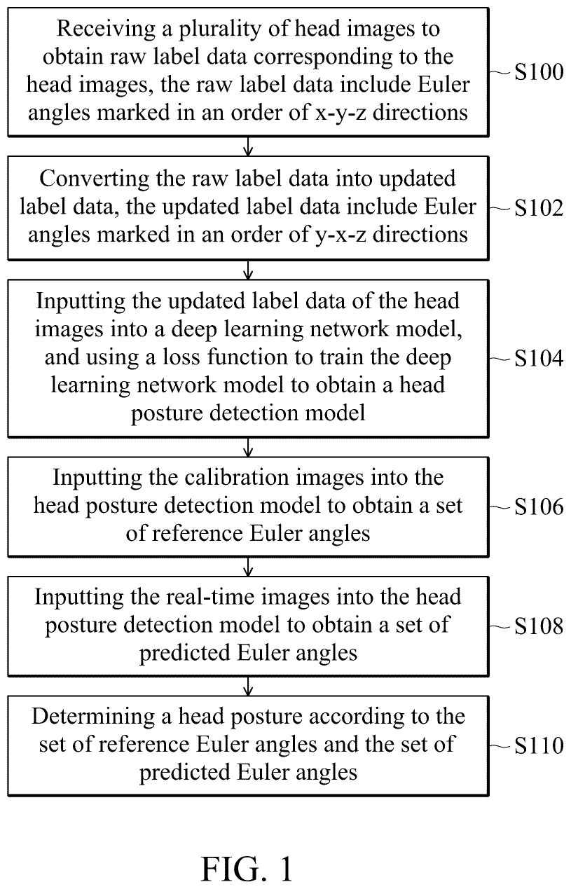

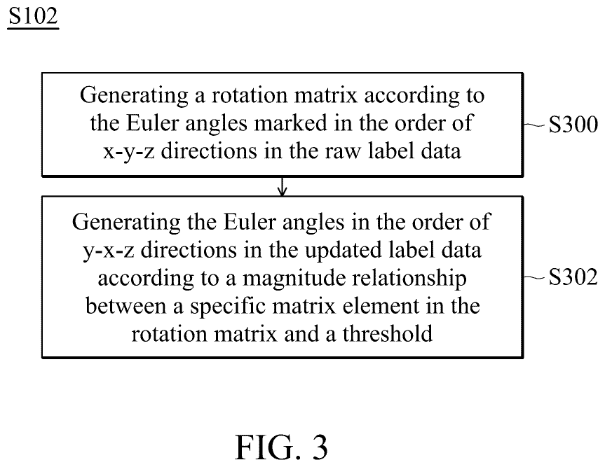

FIG. 1 shows a flow chart of a method for head posture judgment in accordance with some embodiments of the present invention. As shown in FIG. 1, the method for head posture judgment of the present invention includes the following steps. A plurality of head images are received to obtain raw label data corresponding to the head images. The raw label data include Euler angles marked in order of the x-y-z directions (step S100). The raw label data are converted into updated label data. The updated label data include Euler angles marked in order of the y-x-z directions (step S102). The updated label data of the head images are input into a deep learning network model and the model is trained using a loss function to obtain a head posture detection model (step S104). Calibration images are input into the head posture detection model to obtain a set of reference Euler angles (step S106). Real-time images are input into the head posture detection model to obtain a set of predicted Euler angles (step S108). The head posture is determined according to the set of reference Euler angles and the set of predicted Euler angles (step S110). The above steps S102, S104, and S110 will be described in more detail using FIGS. 3, 4, and 5 respectively.

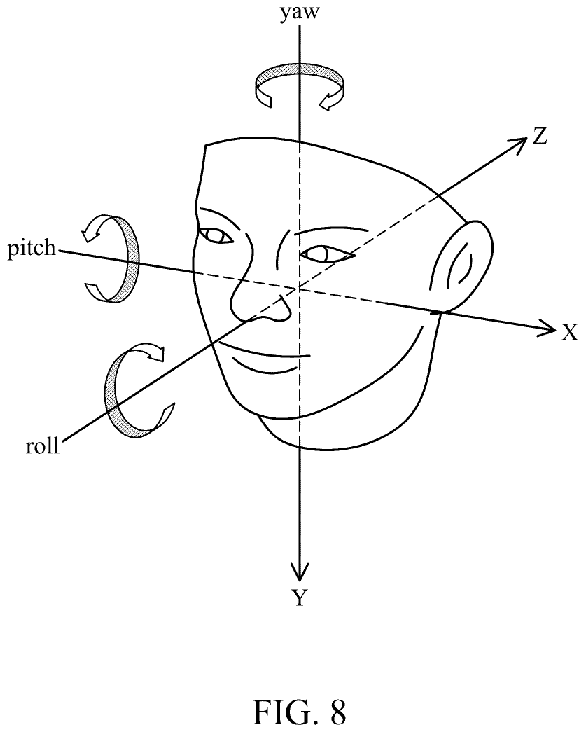

In step S100, the head images may be, for example, from a camera, and the camera is disposed on a vehicle, but the present invention is not limited thereto. In some embodiments, the camera may be, for example, disposed around a driver's seat, but the present invention is not limited thereto. In some embodiments, the raw label data include the Euler angles marked in the order of x-y-z directions, which may be, for example, pitch, yaw, and roll in sequence. In other words, the pitch, the yaw, and the roll are marked in the head image in sequence based on the raw label data. FIG. 8 shows a schematic diagram of coordinate axes of a driver's head and their corresponding rotation angles in accordance with some embodiments of the present invention. In some embodiments, as shown in FIG. 8, a positive direction of x is from the right to the left of a driver, a positive direction of y is from the top to the bottom of the driver, and the positive direction of z is from the front to the back of the driver. The angle of rotation around the x-axis is recorded as the pitch, which indicates the driver is looking up or down. The angle of rotation around the y-axis is recorded as the yaw, which indicates the driver's left head turn or right head turn. The angle of rotation around the z-axis is recorded as the roll, which indicates the driver's left head tilt or right head tilt, but the present invention is not limited thereto. Then, in step S102, the updated label data include the Euler angles marked in the order of y-x-z directions, which may be, for example, yaw, pitch, and roll in sequence.

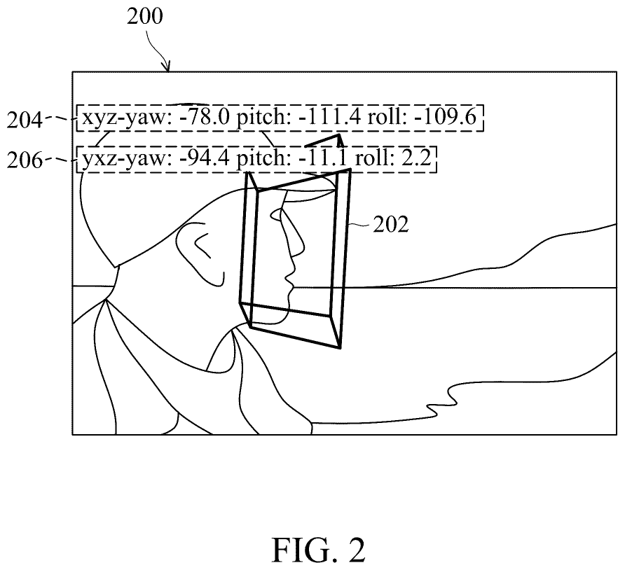

FIG. 2 shows a schematic diagram of a head image 200 in steps S100 and S102 of FIG. 1 in accordance with some embodiments of the present invention. As shown in FIG. 2, the method for head posture judgment of the present invention receives a head image 200 from the camera. The head image 200 may, for example, include a face recognition block 202, raw label data 204 and updated label data 206. In some embodiments of FIG. 2, the head of a person in the head image 200 is turned nearly 90 degrees to the left. The raw label data include the pitch of −111.4 degrees, the yaw of −78.0 degrees, and the roll of −109.6 degrees, those marked in order of the x-y-z directions. Since the raw label data may have the Gimbal lock problem when the yaw is close to 90 degrees, the pitch and the roll may be unstable and fluctuate greatly, resulting in inaccurate Euler angles. After the method for head posture judgment of the present invention executes step S102, the updated label data 206 in the head image 200 are obtained. The updated label data 206 are marked in the order of y-x-z directions, and accurate Euler angles may be obtained, where the yaw is −94.4 degrees, the pitch is −11.1 degrees, and the roll is 2.2 degrees.

In some embodiments of FIG. 2, since the head of the person in the head image 200 is turned nearly 90 degrees to the left, the pitch and roll of the raw label data 204 may be unstable and fluctuate greatly due to the Gimbal lock problem. That is, the Gimbal lock problem occurs when the angle in the second dimension is close to 90 degrees, causing the angles in other dimensions to become unstable and prone to ambiguity. In the driving scenario, the pitch corresponds to the driver's head turning up or down, the yaw corresponds to the driver's head turning left or right, and the roll corresponds to the driver's head tilting left or right. In the current driving scenario, the yaw in the second dimension, that is, the driver's left and right turn of the head, is more likely to be close to 90 degrees, which may easily lead to Gimbal lock problems. However, in the updated label data, the second dimension has been replaced with the pitch angle, which corresponds to the driver's upward or downward head movement. It is unlikely to approach 90 degrees, thus helping to avoid the Gimbal lock problem. As a result, the pitch and roll angles in the updated label data exhibit stable and accurate values. In other words, in step S102, the method for head posture judgment of the present invention converts the raw label data 204 into the updated label data 206 to avoid the Gimbal lock problem.

FIG. 3 shows a detail flow chart of step S102 in FIG. 1 in accordance with some embodiments of the present invention. As shown in FIG. 3, the method for head posture judgment of the present invention includes the following steps. A rotation matrix is generated according to the Euler angles marked in the order of x-y-z directions in the raw label data (step S300). The Euler angles in the order of y-x-z directions in the updated label data are generated according to a magnitude relationship between a specific matrix element in the rotation matrix and a threshold (step S302). In detail, the rotation matrix in step S300 in FIG. 3 may, for example, be shown as follows.

$$equation 1$$

$$R = [ \begin{matrix}{R}_{00} & {R}_{01} & {R}_{02} \\ {R}_{10} & {R}_{11} & {R}_{12} \\ {R}_{20} & {R}_{21} & {R}_{22}\end{matrix} ] = [ \begin{matrix}cos y cos r & - cos y sin r & sin y \\ \begin{matrix}cos p sin r + \\ cos r sin p sin y\end{matrix} & \begin{matrix}cos p cos r - \\ sin p sin y sin r\end{matrix} & - cos y sin p \\ \begin{matrix}sin p sin r - \\ cos p cos r sin y\end{matrix} & \begin{matrix}cos r sin p + \\ cos p sin y sin r\end{matrix} & cos p cos y\end{matrix} ] .$$

In equation 1, R is the rotation matrix, R₀₀, R₀₁, R₀₂, R₁₀, R₁₁, R₁₂, R₂₀, R₂₁, R₂₂ are matrix elements. p is a pitch marked in the raw label data. y is a yaw marked in the raw label data. r is a roll marked in the raw label data.

In step S302 in FIG. 3, if a specific matrix element (for example, the matrix element R₁₂) exceeds the threshold (for example, 0.99), the pitch, the roll and the yaw marked in the updated label data are obtained using the following equation 2.

$${p}_{n e w} = - \frac{π}{2} ; {y}_{n e w} = 0 ; {r}_{n e w} = arctan 2 ( - {R}_{01} , {R}_{00} ) . \qquad equation 2$$

In equation 2, p_{new} is a pitch marked in the updated label data. y_{new} is a yaw marked in the updated label data. r_{new} is a roll marked in the updated label data.

In step S302 in FIG. 3, if the specific matrix element (for example, the matrix element R₁₂) is less than an inverse value of the threshold (for example, −0.99), the pitch, the roll and the yaw marked in the updated label data are obtained using the following equation 3.

$${p}_{n e w} = - \frac{π}{2} ; {y}_{n e w} = 0 ; {r}_{n e w} = arctan 2 ( - {R}_{01} , {R}_{00} ) . \qquad equation 3$$

In step S302 in FIG. 3, if the specific matrix element (for example, the matrix element R₁₂) is between the threshold (for example, 0.99) and the inverse of the threshold (for example, −0.99), the roll and the yaw marked in the updated label data are obtained using the following equation 4.

$${p}_{n e w} = - arcsin ( {R}_{12} ) ; \qquad equation 4$$

$${y}_{n e w} = arctan 2 ( {R}_{02} / cos {p}_{n e w} , {R}_{22} / cos {p}_{n e w} ) ;$$

$${r}_{n e w} = arctan 2 ( {R}_{10} / cos {p}_{n e w} , {R}_{11} / cos {p}_{n e w} ) .$$

In step S302 in FIG. 3, the method for head posture judgment of the present invention converts the raw label data into the updated label data through equations 1, 2, 3, and 4 to avoid Gimbal lock problem when the angle in the second dimension is close to 90 degrees.

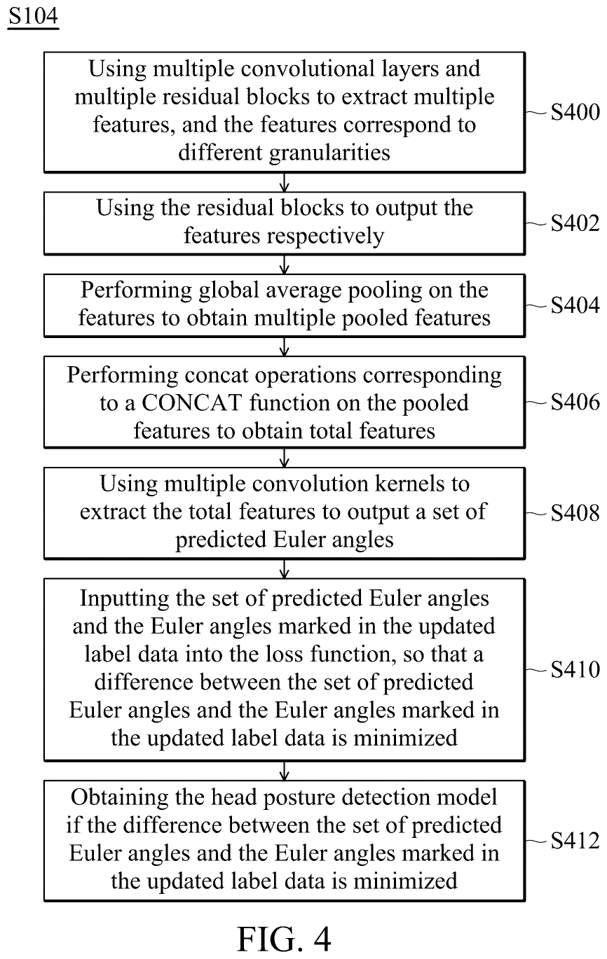

FIG. 4 shows a detail flow chart of step S104 in FIG. 1 in accordance with some embodiments of the present invention. As shown in FIG. 4, the method for head posture judgment of the present invention includes multiple convolution layers. The convolution layers include 4 residual blocks. The method for head posture judgment of the present invention extracts different fine-grained features from the 4 residual blocks respectively, and the fine-grained features correspond to different granularities (steps S400 and S402). After that, the method for head posture judgment of the present invention performs global average pooling on the fine-grained features to obtain 4-layer pooled features (step S404). Then, the method for head posture judgment of the present invention performs concat operations corresponding to a CONCAT function on the 4-layer pooled features to obtain total features (step S406), and uses multiple convolution kernels to extract the total features to output a set of predicted Euler angles (step S408).

In some embodiments of FIG. 4, the method for head posture judgment of the present invention further inputs the set of predicted Euler angles and the Euler angles marked in the updated label data into the loss function, so that the difference between the set of predicted Euler angles and the Euler angles marked in the updated label data is minimized (step S410), and obtains the head posture detection model if the difference between the set of predicted Euler angles and the Euler angles marked in the updated label data is minimized (step S412).

In step S400 in FIG. 4, the deep learning network model includes multiple convolution layers and residual blocks. For example, the method for head posture judgment of the present invention inputs the head image with a granularity of 128*128*3 to the deep learning network model in step S400. The convolution layers and the residual blocks in the deep learning network model extract multiple features in the head image. Then, in step S402, the residual blocks in the deep learning network model output its extracted features. In some embodiments, the deep learning network model may include, for example, 14 convolution layers and 4 residual blocks, but the present invention is not limited thereto. In step S404, the method for head posture judgment of the present invention uses the following equations 5-8 to perform global pooling on the features output by the 4 residual blocks.

$$avg\_ 1 = global\_avg \_pool ( r 1 ) ( 1 * 1 * 128 ) . \qquad equation 5$$

$$avg\_ 2 = global\_avg \_pool ( r 2 ) ( 1 * 1 * 256 ) . \qquad equation 6$$

$$avg\_ 3 = global\_avg \_pool ( r 3 ) ( 1 * 1 * 512 ) . \qquad equation 7$$

$$avg\_ 4 = global\_avg \_pool ( r 4 ) ( 1 * 1 * 1024 ) . \qquad equation 8$$

In equation 5 to equation 8, the method for head posture judgment of the present invention performs global pooling on the output r1 to r4 of the 1st to 4th layer residual block to obtain avg_1 to avg_4 pooled features. The granularity of the pooled features avg_1 to avg_4 may be, for example, 1*1*128, 1*1*256, 1*1*512 and 1*1*1024, respectively.

Then, in step S406, the method for head posture judgment of the present invention performs concat operations (CONCAT function) on the pooled features using the following equation 9 to obtain total features.

$$avg\_total = concat ( avg\_ 1 , avg\_ 2 , avg\_ 3 , avg\_ 4 ) ( 1 * 1 * 1920 ) . \qquad equation 9$$

In equation 9, the method for head posture judgment of the present invention performs the concat operations (CONCAT function) on the pooled features avg_1, the pooled features avg_2, the pooled features avg_3, and the pooled features avg_4 to obtain total features avg_total. The granularity of the total features avg_total may be, for example, 1*1*1920.

In step S408, the method for head posture judgment of the present invention uses the convolution kernels with the granularity of 1*1*1920*3, for example, to extract the total features avg_total to output the predicted Euler angles. The predicted Euler angles may include, for example, the pitch, the yaw, and the roll. Then, in step S410, the method for head posture judgment of the present invention inputs the predicted Euler angles and the Euler angles marked in the updated label data into the loss function, so that the difference between the predicted Euler angles and the Euler angles marked in the updated label data is minimized. The loss function may be, for example, the following equation 10.

$$equation 10$$

$$L = \frac{1}{N} {\sum }_{n = 1}^{N} ( {( {p}_{pred} - {p}_{true} )}^{2} + {( {y}_{pred} - {y}_{true} )}^{2} + {( {r}_{pred} - {r}_{true} )}^{2} ) * ( 1 - α * mask ) ,$$

$$and$$

$$mask = σ ( {y}_{pred} - ref ) * σ ( {y}_{true} - ref ) + σ ( - {y}_{pred} - ref ) * σ ( - {y}_{true} - ref ) .$$

In equation 10, L is the difference; N is the number of head images; p_{pred} is a pitch in the set of predicted Euler angles output by the deep learning network model; y_{pred} is a yaw in the set of predicted Euler angles output by the deep learning network model; r_{pred} is a roll in the set of predicted Euler angles output by the deep learning network model; pₜᵣᵤₑ is a pitch marked in the updated label data; yₜᵣᵤₑ is a yaw marked in the updated label data; and rₜᵣᵤₑ is a roll marked in the updated label data. a is a sigmoid function. ref is an adjustment coefficient, indicating the yaw that needs to be stabilized. In some embodiments, the method for head posture judgment of the present invention obtains the head posture detection model if the difference between the predicted Euler angles and the Euler angles marked in the updated label data is minimized. In other words, the deep learning network model has been trained to obtain the head posture detection model in practical applications.

Compared with the commonly used MAE (Mean Absolute Error) loss function, the method for head posture judgment of the present invention uses the loss function in Equation (10), which, on the one hand, employs the square of the mean absolute error to better suppress large angle differences. On the other hand, the Sigmoid function is used at the same time to smooth the loss caused by the angle difference when the detected and true values of the left and right turning angles (i.e., the yaw) exceed the adjustment coefficient ref, thereby reducing the error of large-angle side face label data and the fluctuation of detection results caused by the lack of facial details.

Return to step S106 in FIG. 1. In step S106, the method for head posture judgment of the present invention enters a calibration mode, and inputs the calibration images into the head posture detection model obtained in step S412 to obtain the set of reference Euler angles. In some embodiments, the reference Euler angles may include, for example, a reference pitch p_{base}, a reference yaw y_{base}, and a reference roll r_{base}. In some embodiments, a driver in the calibration images is looking straight ahead at a road in a normal driving posture. Then, in step S108, the method for head posture judgment of the present invention enters a detection mode, and inputs the real-time images into the head posture detection model obtained in step S412 to obtain a set of predicted Euler angles. In some embodiments, the predicted Euler angles may include, for example, a predicted pitch p_{pred}, a predicted yaw y_{pred}, and a predicted roll r_{pred}.

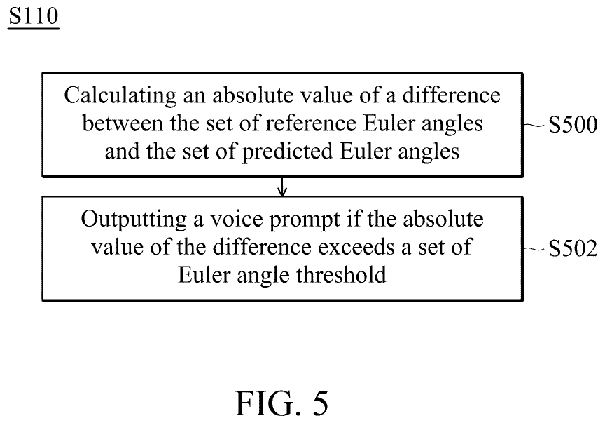

FIG. 5 shows a detail flow chart of step S110 in FIG. 1 in accordance with some embodiments of the present invention. In step S110, the method for head posture judgment of the present invention determines the head posture according to the reference Euler angles and the predicted Euler angles. As shown in FIG. 5, the method for head posture judgment of the present invention calculates the absolute value of the difference between the reference Euler angles and the predicted Euler angles (step S500), and outputs a voice prompt if the absolute value of the difference exceeds a set of Euler angle thresholds (step S502). In some embodiments, the Euler angle thresholds include a pitch threshold threshₚ, a yaw threshold thresh_{y}, and a roll threshold threshᵣ.

In detail, if the absolute value of the difference between the predicted pitch p_{pred} and the reference pitch p_{base} exceeds the pitch threshold threshₚ, that is abs (p_{pred}−p_{base}>threshₚ), the method for head posture judgment of the present invention determines if the driver is in a large head-up or head-down position, and may issue corresponding voice prompts. In some embodiments, the pitch threshold threshₚ may be, for example, substantially equal to 20, but the present invention is not limited thereto. The pitch threshold threshₚ may be determined according to requirements.

If the absolute value of the difference between the predicted yaw y_{pred} and the reference yaw y_{base} exceeds the yaw threshold thresh_{y}, that is abs(y_{pred}−y_{base}>thresh_{y}), the method for head posture judgment of the present invention determines the head is in a large left or right turning position, and may issue corresponding voice prompts. In some embodiments, the yaw threshold thresh_{y} may be, for example, substantially equal to 40, but the present invention is not limited thereto. The yaw threshold thresh_{y} may be determined according to requirements.

If the absolute value of the difference between the predicted roll r_{pred} and the reference roll r_{base} exceeds the roll threshold threshᵣ, that is abs(r_{pred}−r_{base}>threshᵣ), the method for head posture judgment of the present invention determines if the driver is in a large left or right head-tilting position, and may issue corresponding voice prompts. In some embodiments, the roll threshold threshᵣ may be, for example, substantially equal to 30, but the present invention is not limited thereto. The roll threshold threshᵣ may be determined according to requirements.

In a general scenario, the pitch threshold threshₚ, pitch threshold threshₚ, and the roll threshold threshᵣ are integers or decimals that are disposed between 20 and 50.

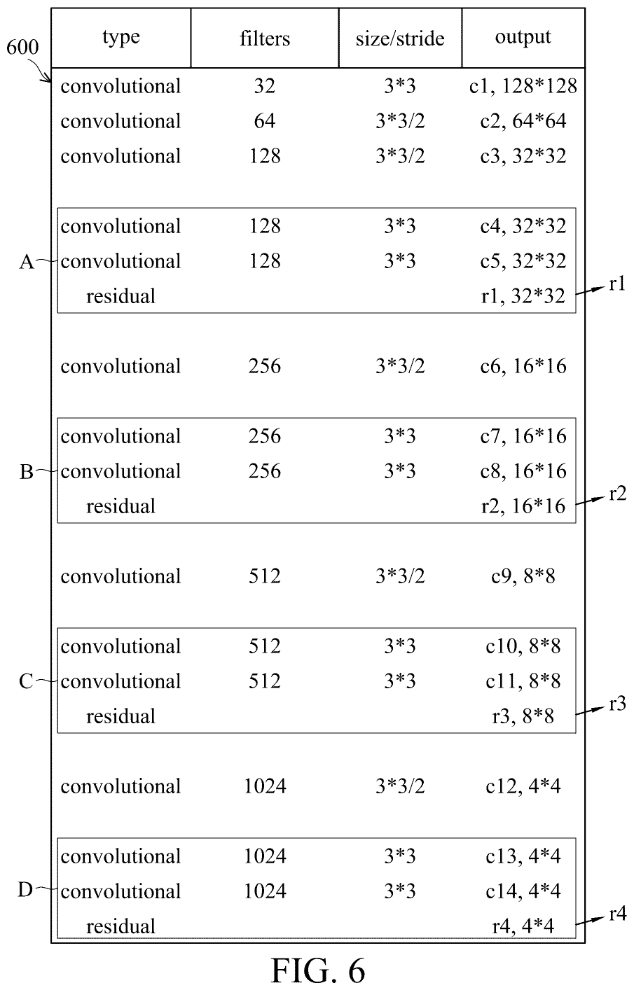

FIG. 6 shows a schematic diagram of a structure of a deep learning network model 600 in step S104 in FIG. 1 in accordance with some embodiments of the present invention. As shown in FIG. 6, the deep learning network model 600 includes 14 convolution layers divided into 4 residual blocks. For example, the first convolution layer includes 32 filters, each of which has a size of 3*3, a stride of 1, and may output an output value c1 with a granularity of 128*128. The second convolution layer includes 64 filters, each of which has a size of 3*3, a stride of 2, and may output an output value c2 with a granularity of 64*64. The second convolutional layer may, for example, perform a convolution operation on the output value c1 from the first convolutional layer. The third convolution layer includes 128 filters, each of which has a size of 3*3, a stride of 2, and may output an output value c3 with a granularity of 32*32. The third convolutional layer may, for example, perform a convolution operation on the output value c2 from the second convolutional layer. The fourth convolution layer includes 128 filters, each of which has a size of 3*3, a stride of 1, and may output an output value c4 with a granularity of 32*32. The fourth convolutional layer may, for example, perform a convolution operation on the output value c3 from the third convolutional layer. The fifth convolution layer includes 128 filters, each of which has a size of 3*3, a stride of 1, and may output an output value c5 with a granularity of 32*32.

The first residual block receives the output value c5 from the fifth convolutional layer, performs a residual operation on the output value c5 and outputs feature r1. In some embodiments of FIG. 6, the fourth convolutional layer, the fifth convolutional layer and the first residual block are included in a block A. The structure of other blocks of the deep learning network model 600 is similar to the structure described in this paragraph. For example, the second residual block in block B outputs feature r2. The third residual block in block C outputs feature r3. The fourth residual block in block D outputs feature r4. After that, the method for head posture judgment of the present invention executes step S404 in FIG. 4 to perform global pooling on features r1-r4.

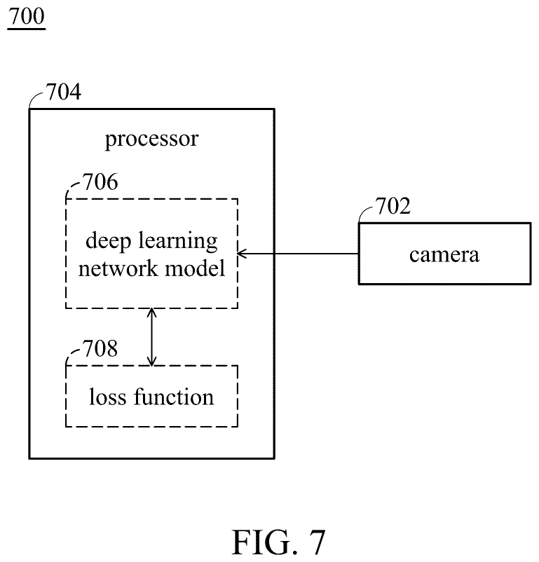

FIG. 7 shows a schematic diagram of a vehicle-mounted system 700 in accordance with some embodiments of the present invention. As shown in FIG. 7, the vehicle-mounted system 700 includes a camera 702 and a processor 704. In some embodiments, the camera 702 may be disposed, for example, around the driver's seat, but the present invention is not limited thereto. The camera 702 outputs a plurality of head images. The head images at least include calibration images and real-time images. The processor 704 is electrically connected to the camera 702. The processor 704 may execute steps S100 S110 in FIG. 1, steps 300 and 302 in FIG. 3, steps S400˜S412 in FIG. 4, and steps S500 and S502 in FIG. 5. In some embodiments of FIG. 7, when the processor 704 executes steps S100 and S102, the processor 704 generates a rotation matrix according to the Euler angles marked in the order of x-y-z directions in the raw label data. Then, the processor 704 generates the Euler angles in the order of y-x-z directions in the updated label data according to a magnitude relationship between a specific matrix element in the rotation matrix and a threshold. In some embodiments of FIG. 7, a positive direction of y is from the top to the bottom of a driver, a positive direction of x is from the right to the left of the driver, and the positive direction of z is from the front to the back of the driver.

When the processor 704 executes step S104, for example, the processor 704 inputs the updated label data of the head images into a deep learning network model 706, and using a loss function 708 to train the deep learning network model 706 to obtain a head posture detection model. In some embodiments, the deep learning network model 706 may be, for example, the deep learning network model 600 in FIG. 6. In detail, the processor 704 uses convolutional layers and residual blocks in the deep learning network model 706 to extract multiple features in the head images. The processor 704 uses the residual blocks to output features respectively. The processor 704 performs a global average pooling on the features to obtain multiple pooled features. The processor 704 performs a concat operation (CONCAT function) on the pooled features to obtain a total feature. The processor 704 uses multiple convolution kernels to extract the total features to output predicted Euler angles. Then, the processor 704 inputs the predicted Euler angles and the Euler angles marked in the updated label data into the loss function 708, so that the difference between the predicted Euler angles and the Euler angles marked in the updated label data is minimized. The processor 704 obtains the head posture detection model if the difference between the set of predicted Euler angles and the Euler angles marked in the updated label data is minimized. That is, the training of the deep learning network model 706 has been completed.

The method for head posture judgment and the vehicle-mounted system 700 of the present invention have the following advantages. First, the detection network has a small amount of computation, simple post-processing, and a short overall time consumption. It is very suitable for application scenarios with limited computing power such as vehicle-mounted equipment, and can meet the real-time requirements in actual applications. Second, the detection output angle is more stable and smoother. When the head turns at a large angle, the detection results are also very stable and accurate. The detection results for various scenes have good robustness.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for head posture judgment, comprising:
receiving a plurality of head images to obtain raw label data corresponding to the head images; wherein the raw label data comprise Euler angles marked in order of x-y-z directions;
converting the raw label data into updated label data; wherein the updated label data comprise Euler angles marked in order of y-x-z directions;
inputting the updated label data of the head images into a deep learning network model, and using a loss function to train the deep learning network model to obtain a head posture detection model; and
inputting calibration images and real-time images into the head posture detection model to determine head posture.

2. The method for head posture judgment as claimed in claim 1, wherein the Euler angles in the order of y-x-z directions are yaw, pitch, and roll.

3. The method for head posture judgment as claimed in claim 1, wherein the step of converting the raw label data into the updated label data comprises:
generating a rotation matrix according to the Euler angles marked in the order of x-y-z directions in the raw label data; and
generating the Euler angles in the order of y-x-z directions in the updated label data according to a magnitude relationship between a specific matrix element in the rotation matrix and a threshold.

4. The method for head posture judgment as claimed in claim 3, wherein the rotation matrix is as follows,
$$R = [ \begin{matrix}{R}_{00} & {R}_{01} & {R}_{02} \\ {R}_{10} & {R}_{11} & {R}_{12} \\ {R}_{20} & {R}_{21} & {R}_{22}\end{matrix} ] = [ \begin{matrix}cos y cos r & - cos y sin r & sin y \\ \begin{matrix}cos p sin r + \\ cos r sin p sin y\end{matrix} & \begin{matrix}cos p cos r - \\ sin p sin y sin r\end{matrix} & - cos y sin p \\ \begin{matrix}sin p sin r - \\ cos p cos r sin y\end{matrix} & \begin{matrix}cos r sin p + \\ cos p sin y sin r\end{matrix} & cos p cos y\end{matrix} ] ;$$
wherein R is the rotation matrix, and R₀₀, R₀₁, R₀₂, R₁₀, R₁₁, R₁₂, R₂₀, R₂₁, and R₂₂ are matrix elements;
wherein p is a pitch marked in the raw label data; y is a yaw marked in the raw label data; and r is a roll marked in the raw label data.

5. The method for head posture judgment as claimed in claim 4, wherein if the specific matrix element exceeds the threshold, the pitch, the yaw and the roll marked in the updated label data are obtained using the following equation:
$${p}_{n e w} = - \frac{π}{2} ; {y}_{n e w} = 0 ; {r}_{n e w} = arctan 2 ( - {R}_{01} , {R}_{00} ) ;$$
wherein p_{new} is a pitch marked in the updated label data; y_{new} is a yaw marked in the updated label data; and r_{new} is a roll marked in the updated label data;
wherein the specific matrix element is R₁₂, and the threshold is substantially equal to 0.99.

6. The method for head posture judgment as claimed in claim 4, wherein if the specific matrix element is less than an inverse of the threshold, the pitch, the yaw and the roll marked in the updated label data are obtained using the following equation:
$${p}_{n e w} = \frac{π}{2} ; {y}_{n e w} = 0 ; {r}_{n e w} = arctan 2 ( - {R}_{01} , {R}_{00} ) ;$$
wherein p_{new} is a pitch marked in the updated label data; y_{new} is a yaw marked in the updated label data; and r_{new} is a roll marked in the updated label data;
wherein the specific matrix element is R₁₂, and the threshold is substantially equal to 0.99.

7. The method for head posture judgment as claimed in claim 4, wherein if the specific matrix element is between the threshold and the inverse of the threshold, the pitch, the yaw and the roll marked in the updated label data are obtained using the following equation:
$${p}_{n e w} = - arcsin ( {R}_{12} ) ; {y}_{n e w} = arctan 2 ( {R}_{02} / cos {p}_{n e w} , {R}_{22} / cos {p}_{n e w} ) ;$$
$${r}_{n e w} = arctan 2 ( {R}_{10} / cos {p}_{n e w} , {R}_{11} / cos {p}_{n e w} ) ;$$
wherein p_{new} is a pitch marked in the updated label data; y_{new} is a yaw marked in the updated label data; and r_{new} is a roll marked in the updated label data;
wherein the specific matrix element is R₁₂, and the threshold is substantially equal to 0.99.

8. The method for head posture judgment as claimed in claim 1, wherein the step of inputting the updated label data of the head images into the deep learning network model, and using the loss function to train the deep learning network model to obtain the head posture detection model comprises:
using multiple convolutional layers and multiple residual blocks to extract multiple features, and the features correspond to different granularities;
using the residual blocks to output the features respectively;
performing global average pooling on the features to obtain multiple pooled features;
performing concat operations corresponding to a CONCAT function on the pooled features to obtain total features; and
using multiple convolution kernels to extract the total features to output a set of predicted Euler angles.

9. The method for head posture judgment as claimed in claim 8, wherein the step of inputting the updated label data of the head images into the deep learning network model, and using the loss function to train the deep learning network model to obtain the head posture detection model further comprises:
inputting the set of predicted Euler angles and the Euler angles marked in the updated label data into the loss function, so that a difference between the set of predicted Euler angles and the Euler angles marked in the updated label data is minimized; and
obtaining the head posture detection model if the difference between the set of predicted Euler angles and the Euler angles marked in the updated label data is minimized.

10. The method for head posture judgment as claimed in claim 9, wherein the loss function is as follows,
$$L = \frac{1}{N} {\sum }_{n = 1}^{N} ( {( {p}_{pred} - {p}_{true} )}^{2} + {( {y}_{pred} - {y}_{true} )}^{2} + {( {r}_{pred} - {r}_{true} )}^{2} ) * ( 1 - α * mask ) ;$$
$$and$$
$$mask = σ ( {y}_{pred} - ref ) * σ ( {y}_{true} - ref ) + σ ( - {y}_{pred} - ref ) * σ ( - {y}_{true} - ref ) ;$$
wherein L is the difference; N is the number of head images; p_{pred} is a pitch in the set of predicted Euler angles output by the deep learning network model; y_{pred} is a yaw in the set of predicted Euler angles output by the deep learning network model; r_{pred} is a roll in the set of predicted Euler angles output by the deep learning network model; pₜᵣᵤₑ is a pitch marked in the updated label data; yₜᵣᵤₑ is a yaw marked in the updated label data; and rₜᵣᵤₑ is a roll marked in the updated label data;
wherein σ is a sigmoid function; and ref is an adjustment coefficient, indicating the yaw that needs to be stabilized.

11. The method for head posture judgment as claimed in claim 1, wherein the step of inputting the calibration images and the real-time images into the head posture detection model to determine the head posture, comprises:
inputting the calibration images into the head posture detection model to obtain a set of reference Euler angles;
inputting the real-time images into the head posture detection model to obtain a set of predicted Euler angles; and
determining the head posture according to the set of reference Euler angles and the set of predicted Euler angles.

12. The method for head posture judgment as claimed in claim 1, wherein a driver in the calibration images is looking straight ahead at a road in a normal driving posture.

13. The method for head posture judgment as claimed in claim 11, wherein the step of determining the head posture according to the set of reference Euler angles and the set of predicted Euler angles comprises:
calculating an absolute value of a difference between the set of reference Euler angles and the set of predicted Euler angles; and
outputting a voice prompt if the absolute value of the difference exceeds a set of Euler angle thresholds.

14. A vehicle-mounted system, comprising:
a camera, configured to output a plurality of head images; wherein the head images at least comprise calibration images and real-time images;
a processor, electrically connected to the camera, configured to:
receive the head images to obtain raw label data corresponding to the head images; wherein the raw label data comprise Euler angles marked in order of the x-y-z directions;
convert the raw label data into updated label data; wherein the updated label data comprise Euler angles marked in order of the y-x-z directions;
input the updated label data of the head images into a deep learning network model, and use a loss function to train the deep learning network model to obtain a head posture detection model;
input the calibration images into the head posture detection model to obtain a set of reference Euler angles;
input the real-time images into the head posture detection model to obtain a set of predicted Euler angles; and
determine the head posture according to the set of reference Euler angles and the set of predicted Euler angles.

15. The vehicle-mounted system as claimed in claim 14, wherein the Euler angles in the order of y-x-z directions are yaw, pitch, and roll.

16. The vehicle-mounted system as claimed in claim 15, wherein a positive direction of y is from the top to the bottom of a driver, a positive direction of x is from the right to the left of the driver, and the positive direction of z is from the front to the back of the driver.

17. The vehicle-mounted system as claimed in claim 14, wherein the processor generates a rotation matrix according to the Euler angles marked in the order of x-y-z directions in the raw label data, and generates the Euler angles in the order of y-x-z directions in the updated label data according to a magnitude relationship between a specific matrix element in the rotation matrix and a threshold.

18. The vehicle-mounted system as claimed in claim 14, wherein the deep learning network model comprises multiple convolution layers and multiple residual blocks to extract multiple features, and the features correspond to different granularities.

19. The vehicle-mounted system as claimed in claim 18, wherein the processor uses the residual blocks to output the features respectively; the processor performs global average pooling on the features to obtain multiple pooled features; the processor performs concat operations corresponding to a CONCAT function on the pooled features to obtain total features; and the processor uses multiple convolution kernels to extract the total features to output a set of predicted Euler angles.

20. The vehicle-mounted system as claimed in claim 19, wherein the processor inputs the set of predicted Euler angles and the Euler angles marked in the updated label data into the loss function, so that a difference between the set of predicted Euler angles and the Euler angles marked in the updated label data is minimized; and the processor obtains the head posture detection model if the difference between the set of predicted Euler angles and the Euler angles marked in the updated label data is minimized.
